(19) United States
(12) Patent Application Publication
(10) Pub. No.: US 2013/0047443 A1
(43) Pub. Date: Feb. 28, 2013

(54) PORTABLE CUTTING TOOL

(71) Applicants: Warren Brown, Mount Evelyn (AU); Graham Gerhardt, Warrandtye (AU); Harry Szommer, Carrum Downs (AU); Yu Zhao, Suzhou (CN); Zhou Zhongya, Suzhou (CN)

(72) Inventors: Warren Brown, Mount Evelyn (AU); Graham Gerhardt, Warrandtye (AU); Harry Szommer, Carrum Downs (AU); Yu Zhao, Suzhou (CN); Zhou Zhongya, Suzhou (CN)

(21) Appl. No.: 13/498,279

(22) PCT Filed: Sep. 21, 2010
(86) PCT No.: PCT/CN2010/077219

§ 371 Date: Jun. 8, 2012

(30) Foreign Application Priority Data
Sep. 24, 2009 (CN) 200910232984.5

(51) Int. Cl. B26B 29/00; B23D 45/16

(52) U.S. Cl. 30/277.4; 30/286

(57) ABSTRACT

The present invention provides a portable cutting tool, which comprises: a blade for cutting workpieces, the blade having a blade plane; a housing; and a moveable guard installed on the housing, wherein the guard is provided with a blade through-hole through which the blade passes, the guard moves between a first position and a second position with respect to the housing, when the guard is located at the first position, the blade does not pass through the blade through-hole, and when the guard is located at the second position, the blade passes through the blade through-hole; either the guard or the housing is provided with an arc guide rail, and the other has position-limiting members which are matched with the arc guide rail to limit the displacement of the guard along the normal direction of the arc guide rail.

### TECHNICAL FIELD

The present invention relates to a power tool, in particular to a portable cutting tool.

### BACKGROUND OF THE INVENTION

The traditional portable cutting tool, such as a portable electric circular saw, usually comprises a circular blade for processing workpieces, a motor for driving the circular blade, and a main handle gripped by an operator during the operation, wherein the output shaft of the motor is usually vertical to the saw blade; and the main handle is positioned vertical to the motor. The electric circular saw comprises a base plate, a fixed guard and a movable guard, the fixed guard is positioned on the upper part of the base plate and receives the upper part of the saw blade at any time, the moveable guard is positioned below the base plate and is rotatable to expose the lower part of the saw blade while working. The traditional electric circular saw is large and heavy and therefore inapplicable to the processing of small and thin workpieces.

European patent EP1177868B1 discloses a small, light and portable electric circular saw which comprises a small circular blade, a motor for driving the circular blade and a housing receiving a drive mechanism, etc, at the front portion and the motor, etc, at the rear portion, wherein the electric circular saw has no individual fixed guard, the front portion receiving the upper part of the saw blade functions as the traditional fixed guard, an individual moveable guard is moveably installed at the front portion; the moveable guard comprises a guard bottom and four side surfaces extending upwards from the bottom, the guard bottom is provided with an opening from which the saw blade extends outside, the moveable guard is positioned around the front portion and is moveable with respect to the front portion to expose the saw blade at differing lengths. This kind of electric circular saw is simple in structure and suitable for cutting thin workpieces.

A linear chute is positioned on the outer wall of the front portion of the electric circular saw disclosed in EP1177868B1, a sliding block is positioned on the inner wall of the movable guard, the sliding block and the chute are matched to make the movable guard slide with respect to the housing, and the chute is also a linear type, so the moveable guard also performs linear motion with respect to the movable guard. The connection mode of the linear chute and the sliding block puts the hand of the operator close to the front portion to apply as much force as possible above the chute, so that the sliding block moves smoothly in the slide chute, which makes the grip unconformable.

Besides, the electric circular guard disclosed in EP1177868B1 and the housing are matched via the chute and the sliding block, the relative motion between the two is sliding, and the friction force between the two is a sliding friction force which is relatively big and makes the operation laborious for the operator.

The patent application coded 200920037895.0 applied for by the applicant on Feb. 6, 2009 discloses a portable circular saw. A portable saw blade comprises a motor, a saw blade, a transmission mechanism positioned between the motor and the circular blade for transmitting a force, a housing having a front portion and a rear portion, and a guard installed at the front portion, wherein the front portion receives the transmission mechanism and at least part of the circular blade, and the rear portion receives the motor; the guard comprises a guard bottom portion which is provided with an opening from which the saw blade extends outside to process workpieces, the guard moves from a first position to a second position with respect to the housing, when the guard is located at the first position, the blade is not exposed outside the opening, and when the guard is located at the second position, the blade is at least partly exposed outside the opening; the guard is provided with an arc groove, and a sphere is installed on the front portion and is capable of rolling along the arc groove to make the guard move between the first position and the second position. The special connection mode of the guard and the front portion of this kind of portable circular saw ensures that the relative motion between the two is the arc motion, so the position gripped by the hand of the operator does not need to be close to the front portion during operation, which saves labor and makes the operation conformable. Usually, two groups of spheres and arc grooves are respectively positioned on the front portion and one side of the guard, so during use, the direction of the force applied by the hand of the operator must be secured as much as possible. Otherwise, if the spheres are susceptible to seizing in the arc grooves when the two groups of spheres move around different circle centres along perspective arc grooves. However, in actual use, different operators have different gripping gestures and apply the force in different directions, and even if the same operator applies the force in different directions at different time, this kind of circular saw is susceptible to dead clamping, which makes cutting very rough.

### SUMMARY OF THE INVENTION

The objective of the present invention is to provide a portable cutting tool reliable in operation.

To solve the mentioned problems, the present invention provides a portable cutting tool which comprises: a blade for cutting workpieces, the blade having a blade plane; a housing; and a moveable guard installed on the housing, wherein the guard has a blade through-hole through which the blade passes, the guard moves between a first position and a second position with respect to the housing, when the guard is located at the first position, the blade does not pass through the blade through-hole, and when the guard is located at the second position, the blade passes through the blade through-hole; either the guard or the housing is provided with an arc guide rail, and the other has position-limiting members which are matched with the arc guide rail to limit the displacement of the guard along the normal direction of the arc guide rail.

In this portable cutting tool, either the guard or the housing is provided with an arc guide rail, and the other has position-limiting members, this special connection mode of the guard and the housing makes the guard always move concentrically with respect to the housing so as to avoid seizing and ensure smooth operation.

The present invention also has the following preferable implementation schemes:

Preferably, the arc guide rail is positioned on the guard and the position-limiting members are positioned on the housing;

Preferably, the arc guide rail is an arc groove.

Preferably, a portable cutting tool of the present invention further comprises an adaptor portion which is matched with the arc guide rail to limit the displacement of the guard along the direction vertical to the blade plane.

Preferably, the arc guide rail in this invention is an arc groove which comprises a groove bottom face, and the adaptor portion comprises a cylinder moving around and linearly contacting the groove bottom face.

Preferably, the arc groove comprises two groove side walls, the position-limiting members are received in the arc groove, the position-limiting members are divided into at least two groups, each of which is selectable to match with one of the groove side walls, and the position-limiting members and the groove side walls are in linear contact.

Preferably, the position-limiting members are at least two bearings.

Preferably, the arc guide rail is an arc groove having a first arc side surface and a second arc side surface, and the position-limiting members are a plurality of bearings, each of which are received in the arc groove and are operable to make contact with the first arc side surface or the second arc side surface linearly.

Preferably, the arc guide rail is an arc opening having a first arc side surface and a second arc side surface which are according to two side of the arc opening, the position-limiting members are several groups of bearings, and each group comprises two bearings which are located on the both sides of the arc opening and are operable to make contact with the first arc side surface or the second arc side surface linearly.

Preferably, the arc guide rail is an arc protrusion having a first arc side surface and a second arc side surface formed on the two corresponding external areas thereof, the position-limiting members are several groups of bearings, and each group comprises two bearings which are located on the two sides of the arc protrusions and are operable to make contact with the first arc side surface or the second arc side surface linearly.

The present invention also provides a portable cutting tool, comprising: a blade, a housing, a moveable guard installed on the housing, wherein the guard has a blade through-hole through which the blade passes, the guard moves between a first position and a second position with respect to the housing, when the guard is located at the first position, the blade does not pass through the blade through-hole, and when the guard is located at the second position, the blade passes through the blade through-hole; either the guard or the housing is provided with an arc guide rail, and the other has position-limiting members, the arc guide rail comprises a first arc side surface and a second arc side surface which are concentric, and the position-limiting members are divided into a first group and a second group which are selectable to make contact with one of the first arc side surface and the second arc side surface linearly.

In this portable cutting tool, either the guard or the housing is provided with the arc guide rail, the other one is provided with the position-limiting members, and this special connection mode of the guard and the housing makes the guard always move concentrically with respect to the housing so as to avoid seizing and ensure smooth operation.

The present invention also has the following preferable implementation schemes:

Preferably, the arc guide rail is positioned on the guard and the position-limiting members are positioned on the housing.

Preferably, the arc guide rail is an arc groove.

Preferably, the arc groove comprises a groove bottom face, and a portable cutting tool further comprises an adaptor portion matched with the groove bottom face.

Preferably, the adaptor portion contacts the groove bottom face linearly.

Preferably, the arc groove comprises two groove side walls, and the first arc side surface and the second arc side surfaces are respectively located on the two groove side walls.

Preferably, the first group of position-limiting members and the second group of position-limiting members are bearings, respectively.

Preferably, the arc guide rail is an arc groove, a first arc side surface and a second arc side surface are two opposite insides of the arc groove, the first group of position-limiting members and the second group of position-limiting members are bearings, respectively, and each bearing is received in the arc groove and is operable to make contact with the first arc side surface or the second arc side surface linearly.

Preferably, the arc guide rail is an arc opening, a first arc side surface and a second arc side surface are two opposite outsides of the arc opening, the first group of position-limiting members and the second group of position-limiting members are two bearings, respectively, which are located on both sides of the arc opening and are operable to make contact with the first or second arc side surface linearly.

Preferably, the arc guide rail is an arc protrusion, a first arc side surface and a second arc side surface are two opposite outsides of the arc protrusion, the first group of position-limiting members and the second group of position-limiting members are two bearings, respectively, which are located on two sides of the arc protrusion and are operable to make contact with the first or second arc side surface linearly.

The present invention also provides a portable cutting tool, which comprises a motor; a blade for cutting workpieces; a tool shaft driven by the motor and used for installing the blade; a housing comprising a front portion for installing the tool shaft, a rear portion for receiving the motor and a gripping portion located between the front portion and the rear portion; and a moveable guard installed on the front portion, wherein the guard has a blade through-hole through which the blade passes, the guard moves between a first position and a second position with respect to the housing, when the guard is located at the first position, the blade does not pass through the blade through-hole, and when the guard is located at the second position, the blade passes through the blade through-hole; and the motor has a motor fan which is located on one side, away from the front portion of the housing, of the motor.

The present invention provides a portable cutting tool comprising: a blade for cutting workpieces, the blade having a blade plane; a housing; and a moveable guard installed on the housing, wherein the guard has a blade through-hole through which the blade passes, the guard moves between a first position and a second position with respect to the housing, when the guard is located at the first position, the blade does not pass through the blade through-hole, and when the guard is located at the second position, the blade passes through the blade through-hole; either the guard or the housing is provided with an arc guide rail which has a first guide rail side surface and a second guide rail side surface at an equal interval, and the other of the two has two position-limiting members in linear contact with the first guide rail side surface and one position-limiting member in linear contact with the second guide rail side surface.

In this portable cutting tool, in virtue of the fitting of the three position-limiting members and the guide rail and the linear contact between two position-limiting members with the first guide rail side surface and between one position-limiting member with the second guide rail side surface, a triangular stable structure consisting of the position-limiting members is realized, so the guard slides stably with respect to the housing and avoids clamping.

The present invention also has the following preferable implementation schemes:

Preferably, the arc guide rail is positioned on the guard and the position-limiting members are positioned on the housing.

Preferably, the guide rail has a longitudinal extension direction, and a position-limiting member in linear contact with the second guide rail side surface is located between the two position-limiting members in linear contact with the first guide rail side surface along the longitudinal extension direction.

Preferably, all the three position-limiting members are located between the first and second guide rail side surfaces.

Preferably, the guide rail is an arc guide rail, and the circle centre of the arc is located outside the portable cutting tool.

Preferably, the opposite faces of the first and second guide rail side surfaces are provided with protrusions which are clamped between the position-limiting members and the housing.

Preferably, the housing is provided with a depth adjusting mechanism, and one side, opposite to the first side wall, of the second side wall has a limiting protrusion matched with the depth adjusting mechanism.

Preferably, the first and second guide rail side surfaces are positioned back to back, and the guide rail is located between the two position-limiting members matched with the first guide rail side surface and one position-limiting members matched with the second guide rail side surface.

Preferably, there are two guide rails respectively matched with three position-limiting members.

The present invention provides a portable cutting tool comprising: a blade for cutting workpieces; a housing; and a moveable guard installed on the housing, wherein the guard has a blade through-hole through which the blade passes, the guard moves between a first position and a second position with respect to the housing, when the guard is located at the first position, the blade does not pass through the blade through-hole, and when the guard is located at the second position, the blade passes through the blade through-hole; either the guard or the housing is provided with a guide rail which has a first guide rail side surface and a second guide rail side surface at an equal interval, the other of the two has a first group of position-limiting members matched with the first guide rail side surface and a second group of position-limiting member matched with the second guide rail side surface, and at least one of the two groups comprises at least one position-limiting member capable of moving with respect to the guide rail to make the first group of position-limiting members in linear contact with the first guide rail side surface and the second group of position-limiting members in linear contact with the second guide rail side surface.

In this portable cutting tool, the position-limiting members able to move transversely with respect to the guide rail are positioned to eliminate tolerance, then the position-limiting members and the guide rail are matched more tightly, so the guard does not shake with respect to the housing and the cutting stability is improved greatly.

The present invention also has the following preferable implementation schemes:

Preferably, the guide rail has a longitudinal extension direction, and at least one of the first and second groups of position-limiting members comprises at least one position-limiting member able to move transversely with respect to the guide rail.

Preferably, at most two of all the position-limiting members included in the first and second groups are unable to move transversely with respect to the guide rail.

Preferably, if two position-limiting members in the first group are unable to move transversely with respect to the guide rail, all position-limiting members in the second group are able to move transversely with respect to the guide rail.

Preferably, the second group consists of one position-limiting member able to move transversely with respect to the guide rail.

Preferably, if one position-limiting member in the first group is unable to move transversely with respect to the guide rail, at most one position-limiting member in the second group is unable to move transversely with respect to the guide rail.

Preferably, both the first and second groups of position-limiting members are located between the first and second guide rail side surfaces.

Preferably, the position-limiting members able to move transversely with respect to the guide rail are bearings fixed on the housing via a pivot, and the inner diameters of the bearings are greater than the diameter of the pivot.

Preferably, all of the first group of position-limiting members and the second group of position-limiting members are bearings.

The present invention provides a portable cutting tool, comprising: a blade for cutting workpieces, the blade having a cutting direction; a tool shaft for installing the blade; a housing; and a moveable guard installed on the housing, wherein the moveable guard has a blade through-hole through which the blade passes, the moveable guard moves between a first position and a second position with respect to the housing, when the moveable guard is located at the first position, the blade does not pass through the blade through-hole, and when the moveable guard is located at the second position, the blade passes through the blade through-hole; a guard-guiding mechanism is positioned between the moveable guard and the housing and is wholly located on one side of the tool shaft where is opposite to the cutting direction.

In this portable cutting tool, the guard-guiding mechanism is wholly positioned at a position close to the rear area of the front portion, and a side which is positioned away from the rear portion of the housing of the moveable guard has no guide structure, so the user is able to observe the position of the blade clearly, which increases convenience during cutting.

The present invention also has the following preferable implementation schemes:

Preferably, the guard-guiding mechanism comprises a guide rail which is located on either the guard or the housing and a position-limiting member located on the other of the two.

Preferably, a blade receiving cavity is formed at a position corresponding to the blade through-hole of the guard, and a through-hole, close to the blade through-hole, is formed on the blade receiving cavity.

Preferably, the guard comprises a guard bottom portion with the blade through-hole, the guard bottom portion has a face for being pressed against a workpiece, and the projection of the tool shaft on the face is located at the middle between the through-hole and the projection of the guard-guiding mechanism on the face.

Preferably, the position-limiting members are respectively positioned on the outsides of the two side surfaces of the housing, which two side surfaces are vertical to the axis of the tool shaft, and two guide rails are respectively matched with the position-limiting members on the two sides of the housing.

Preferably, the guide rail is an arc guide rail, and the circle centre of the arc is located outside the portable cutting tool and away from the rear portion of the housing.

The present invention provides a portable cutting tool, comprising: a motor; a blade for cutting workpieces; a tool shaft for installing the blade; a housing having a front portion installed on the tool shaft and a rear portion for receiving the motor; and a moveable guard installed on the housing, wherein the guard has a blade through-hole through which the blade passes, the guard moves between a first position and a second position with respect to the housing, when the guard is located at the first position, the blade does not pass through the blade through-hole, and when the guard is located at the second position, the blade passes through the blade through-hole; a guard-guiding mechanism is positioned between the guard and the housing and is wholly located between the tool shaft and the motor.

In this portable cutting tool, the guard-guiding mechanism is wholly positioned at the front portion of the housing a position and located between the tool shaft and the rear portion of the housing. The side away from the guard-guiding mechanism of the guard has no guide structure, so the user is able to observe the position of the blade clearly, which increases convenience during cutting.

Preferably, the guard-guiding mechanism comprises a guide rail which is located on either the guard or the housing and a position-limiting member located on the other of the two.

Preferably, a blade receiving cavity is formed at a position, corresponding to the blade through-hole, of the guard, and a through-hole, close to the blade through-hole, is formed on the blade receiving cavity.

Preferably, the guard comprises a guard bottom portion with a blade through-hole, the guard bottom portion has a face for being pressed against a workpiece, and the projection of the tool shaft on the face is located at the middle between the through-hole and the projection of the guard-guiding mechanism on the face.

The present invention provides a portable cutting tool, comprising: a blade for cutting workpieces; a housing; and a moveable guard installed on the housing, wherein the guard has a blade through-hole through which the blade passes, the guard moves between a first position and a second position with respect to the housing, when the guard is located at the first position, the blade does not pass through the blade through-hole, and when the guard is located at the second position, the blade passes through the blade through-hole; either the guard or the housing is provided with a naked guide rail, and the other of the two has at least two position-limiting members matched with the guide rail.

In this portable cutting tool, the guide rail is exposed on the outside, and the guard is easily installed on or dismantled from the housing of the portable cutting tool. The user is able to observe the matching state of the position-limiting members and the guide rail clearly, even if the position-limiting members and the guide rail fail to match with each other, the reasons can be found easily, and thus, convenience is brought to the user.

The present invention also has the following preferable implementation schemes:

Preferably, the guide rail is positioned on the guard and the position-limiting members are positioned on the housing.

Preferably, the guide rail comprises a first guide rail side surface and a second guide rail side surface between which at least two position-limiting members are located.

Preferably, the opposite faces of the first and second guide rail side surfaces are provided with protrusions which are clamped between the position-limiting members and the housing.

Preferably, the housing is provided with a depth adjusting device, and one side, opposite to the first side wall of the second side wall, has a limiting protrusion matched with the depth adjusting device.

Preferably, there are two guide rails respectively matched with three position-limiting members.

Preferably, the guard also has a blade receiving cavity which is matched with the blade through-hole in space and is capable of being partly received in the housing.

Preferably, the guide rail is an arc guide rail, and a circle centre of the arc is located outside the portable cutting tool.

Preferably, the portable cutting tool also comprises a motor, the housing has a front portion and a rear portion, and the circle centre is positioned on one side, away from the rear portion of the housing, of the portable cutting tool.

The present invention also provides a portable cutting tool, comprising a blade for cutting workpieces, a housing; and a moveable guard installed on the housing, wherein either the guard or the housing is provided with a naked guide rail, and the other of the guard and the housing is provided with at least two position-limiting members matched with the guide rail.

### BRIEF DESCRIPTION OF THE DRAWINGS

This invention is further described in details by means of the attached drawings.

FIG. 1 is a three-dimensional view of a portable cutting tool in the first embodiment of the present invention.

FIG. 2 is a two-dimensional view of a portable cutting tool in FIG. 1 without the guard.

FIG. 3 is an internal structural view of a portable cutting tool in FIG. 1 without the guard.

FIG. 4 is a three-dimensional view of the guard of a portable cutting tool in FIG. 1.

FIG. 5 is a three-dimensional view of the guard in FIG. 4 viewed in another angle.

FIG. 6 is a three-dimensional view of the guard of a portable cutting tool in FIG. 1 when the blade is exposed from the guard.

FIG. 7 is a three-dimensional exploded view of a portable cutting tool in FIG. 1.

FIG. 8 is a three-dimensional view of a portable cutting tool in FIG. 1, which is without the guard.

FIG. 9 is a partial enlarged view of a portable cutting tool in FIG. 8 at the position A.

FIG. 10 is a three-dimensional view of a portable cutting tool in FIG. 1 when the wrench is at the open position.

FIG. 11 is a three-dimensional view of the depth regulating mechanism of a portable cutting tool in FIG. 10.

FIG. 12 is an internal structural view of a portable cutting tool, as shown in FIG. 1, with the guard and with the gearbox open.

FIG. 13 is an exploded view of a portable cutting tool, as shown in FIG. 1, before the base plate is installed on the guard.

FIG. 14 is a partial exploded view of a portable cutting tool as shown in FIG. 1.

FIG. 15 is an internal structural view of a portable cutting tool, as shown in FIG. 1, with the guard.

FIG. 16 is part of the schematic view of a portable cutting tool in the second embodiment of the present invention.

FIG. 17 is part of the schematic view of a portable cutting tool in the third embodiment of the present invention.

FIG. 18 is a front view of a portable cutting tool in the fourth embodiment of the present invention.

FIG. 19 is a three-dimensional view of the guard of a portable cutting tool as shown in FIG. 18.

FIG. 20 is part of the three-dimensional view of a portable cutting tool, as shown in FIG. 18, without the guard.

FIG. 21 is a top view of a portable cutting tool as shown in FIG. 18.

FIG. 22 is part of the sectional view of a portable cutting tool, as shown in FIG. 21, along the straight line H-H.

FIG. 23 is a part of the back view of a portable cutting tool as shown in FIG. 18.

### DESCRIPTION OF THE PREFERRED EMBODIMENT

### Embodiment 1

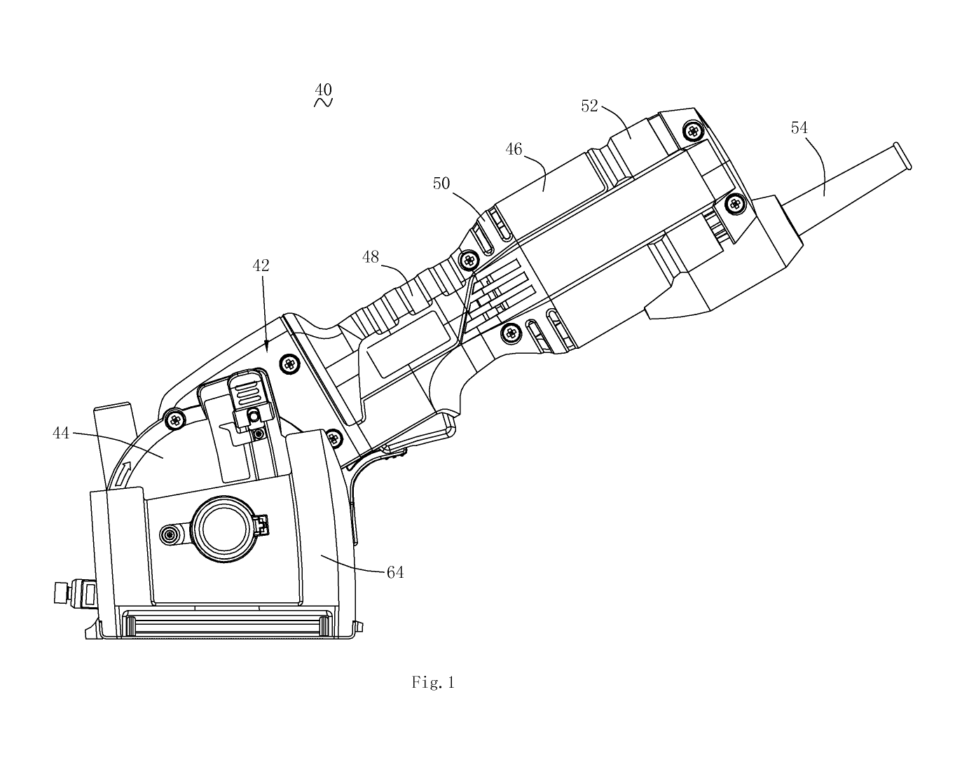

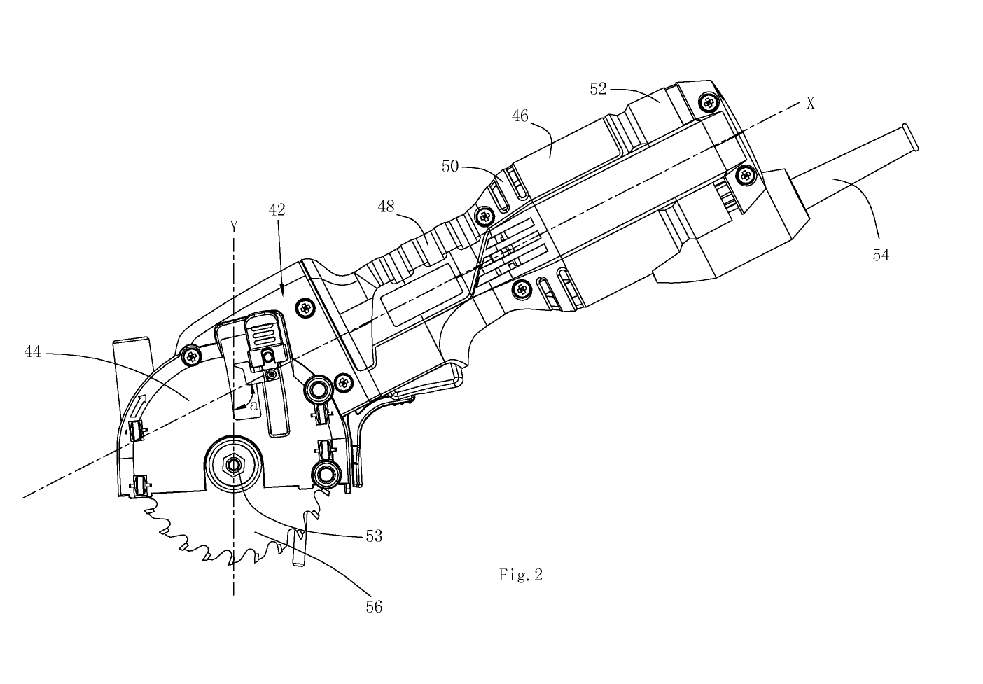

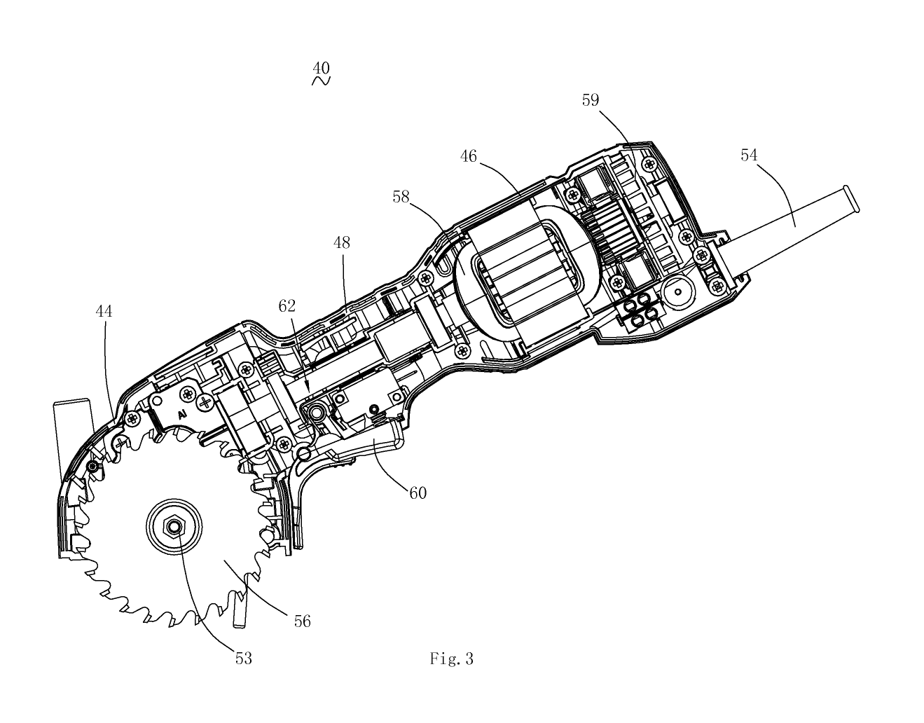

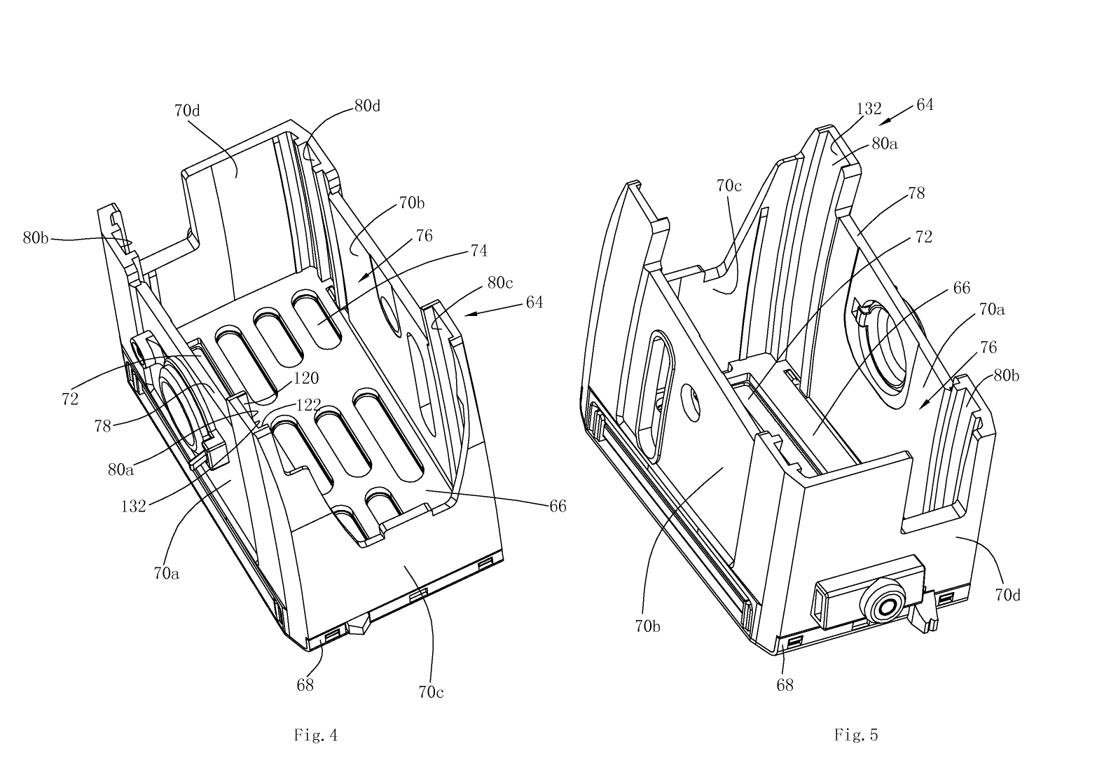

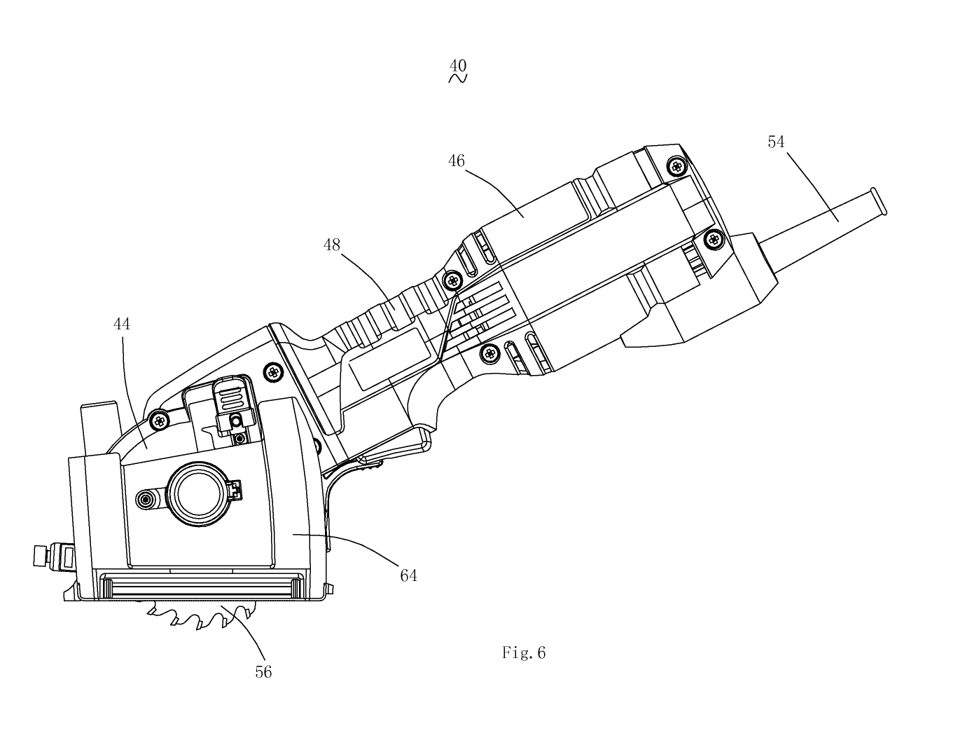

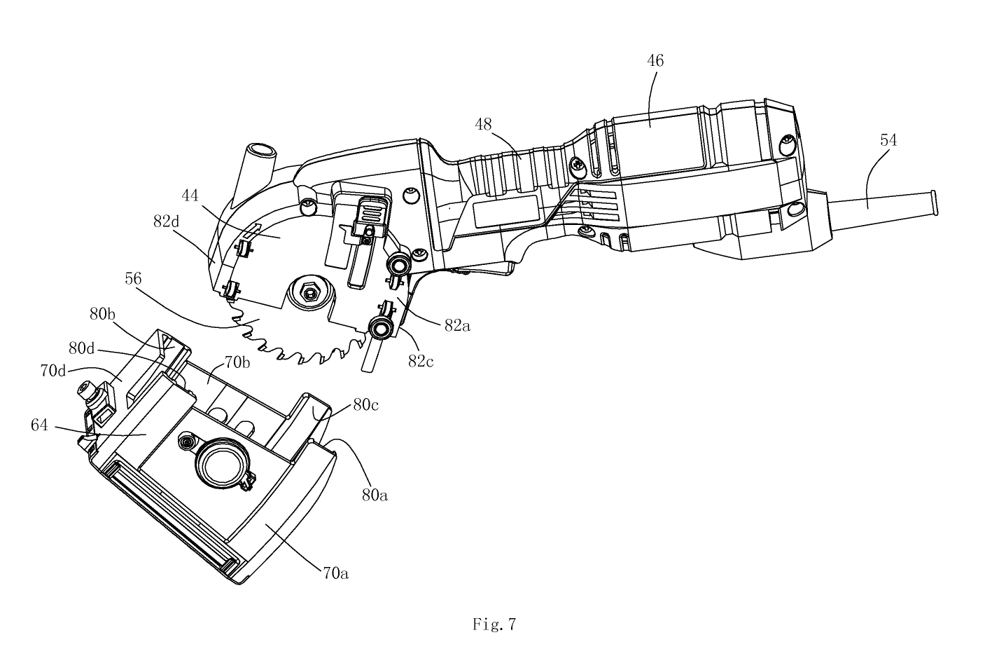

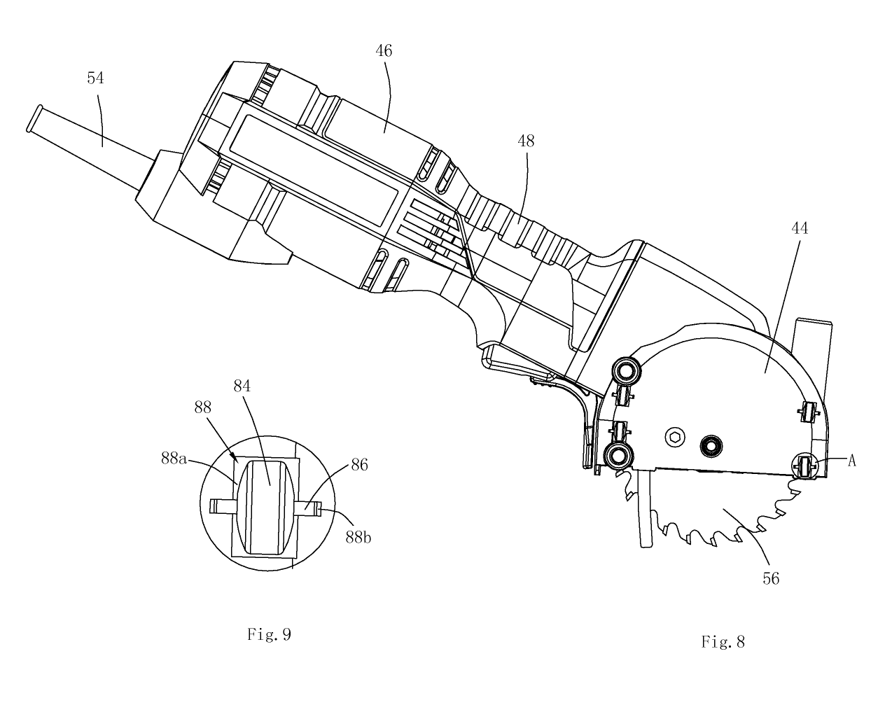

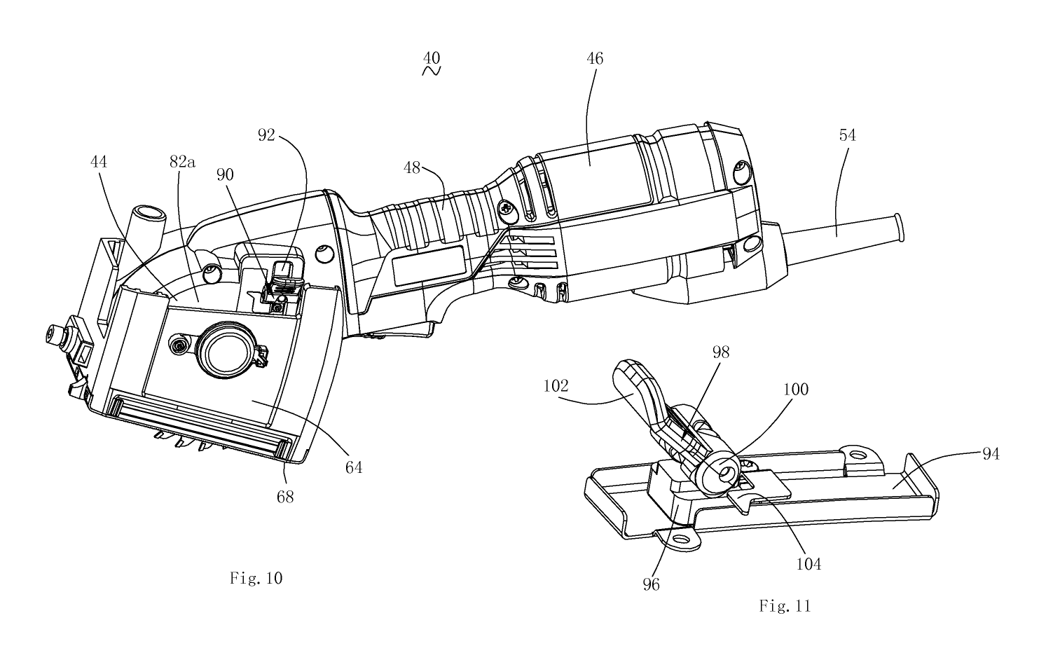

As shown in FIG. 1, a portable cutting tool 40 comprises a housing 42 having a front portion 44, a rear portion 46 and a middle portion connecting the front portion 44 and the rear portion 46. In one embodiment of the present invention, the middle portion of the housing is a gripping portion 48. The housing 42 may be a injection molding piece consisting of two semi-housings. The rear portion 46 of the housing comprises a first end 50 and a second end 52, the first end 50 is in adjacent connection with the gripping portion 48, and the second end 52 is away from the gripping portion 48 and is usually connected to a power cord 54.

As shown in FIG. 2, the gripping portion 48 and the rear portion 46 of the housing basically extend linearly, the longitudinal extension axis of the gripping portion 48 and the rear portion 46 of the housing is X; the front portion 44 of the housing extends in a bent way from the gripping portion 48, and the longitudinal extension axis of the front portion 44 of the housing is Y; the angle α of the longitudinal extension axis Y of the front portion 44 and the longitudinal extension axis X of the gripping portion 48 and the rear portion 46 is more than or equal to 90 degrees, wherein in this embodiment, the angle α is more than 90 degrees.

As shown in FIG. 3, a portable cutting tool 40 comprises a circular blade 56 for cutting workpieces and a motor 58 for driving the circular blade 56. The circular blade 56 has a blade plane. In other embodiments of the present invention, the motor may be a pneumatic motor or hydraulic motor. The circular blade 56 is partly received in the front portion 44 of the housing. The motor 58 is received in the rear portion 46 of the housing and is electrically connected with the power wire 54 to connect an alternating current power supply (not shown in the figure); of course, the motor 58 may also be supplied with power via a direct current battery. A portable cutting tool 40 also comprises a switch 60 which is electrically connected with the motor 58 to control the start and stop of the motor 58.

As shown in FIGS. 2 and 3, the motor 58 is provided with a motor fan 59 which is received at one end, away from the gripping portion 48, of the rear portion 46; an outlet opening 55 around the area of the motor fan 59 is formed at the rear portion 46, and an inlet opening 57 is formed at the joint of the rear portion 46 and the gripping portion 48. The position of the motor fan 59 ensures that the outlet opening is relatively away from the hand or head of the user to prevent the wind from the outlet opening from blowing the hand or head of the user, so the use conformableness is improved.

A transmission mechanism 62 is positioned between the motor 58 and the circular blade 56 for transmitting the power of the motor 58 to the circular blade 56 and driving the circular blade 56 to move by means of the tool shaft 53. The transmission mechanism 62 is respectively received in the front portion 44 and the griping portion 48.

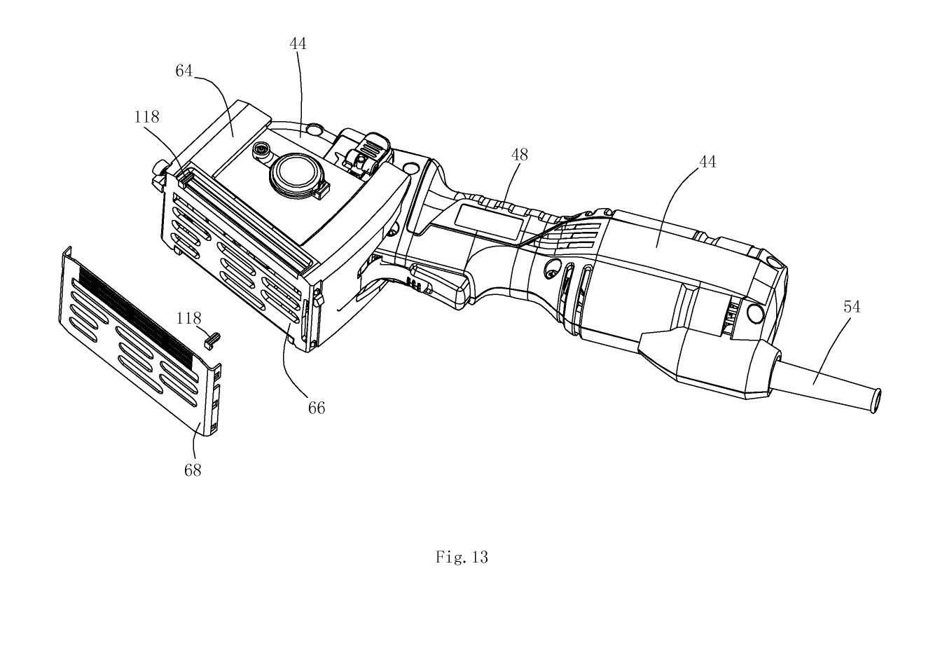

As shown in FIGS. 1, 4 and 5, a portable cutting tool 40 comprises a moveable guard 64 surrounding the front portion 44 circularly, the moveable guard 64 comprises a guard bottom portion 66, wherein in this embodiment, a base plate 68 (as shown in FIG. 13) is installed on the outside of the guard bottom portion 66, and the base plate 68 and the guard bottom portion 66 are fixedly connected via a buckle. In working, the base plate 68 contacts the surfaces of the workpieces. In other embodiments of the present invention, the base plate 68 is not installed on the outside of the guard bottom portion 66, and the guard bottom portion 66 directly contacts the surfaces of the workpieces.

The moveable guard 64 also has four guard side walls 70a-d which surround the circumference and basically extend vertically upward from the guard bottom portion 66, and the guard bottom portion 66 has a blade through-hole 72 through which the circular blade 56 passes. The guard bottom portion 66 has several rows of dust holes 74 through which the dust is discharged. The four guard side walls 70a-d and the guard bottom portion 66 form a cavity 76 for receiving the front portion 44 and the lower part of the circular blade 56. The guard side wall 70a comprises an upper edge 78 which is a side away from the guard bottom portion 66. The specific functions of the upper edge 78 will be described in details later.

As shown in FIGS. 1 and 6, the moveable guard 64 and the front portion 44 are connected via the arc guide rail and the adaptor portion (the arc guide rail and the adaptor portion will be described in details later) to limit the displacement of the guard along the direction vertical to the blade plane. The guide rail is positioned on one of the guards and the front portion, and the adaptor portion is positioned on the other one of the guard and the front portion. The adaptor portion is matched with the arc guide rail and is able to move along the arc guide rail. When the adaptor portion moves along the arc guide rail, the moveable guard 64 moves from a first position to a second position with respect to the front portion 44, when the moveable guard 64 is located at the first position, the circular blade 56 does not pass through the blade through-hole 72 (as shown in FIG. 1) and is therefore not exposed from the moveable guard 64; when the moveable guard 64 is located at the second position, the circular blade 56 at least partly passes through the blade through-hole 72 (as shown in FIG. 6) and is therefore partly exposed from the moveable guard 64, so the portable cutting tool 40 can be used for processing the workpieces.

Further, as shown in FIGS. 4 and 5, the guard side walls 70a and 70b are positioned face to face, while the guard side walls 70c and 70d are positioned face to face, when the moveable guard 64 is installed on the front portion 44, and the guard side walls 70a and 70b are basically in parallel to the circular blade 56 and positioned on the two sides of the circular blade 56. In this embodiment, the arc guide rail is positioned in arc grooves 80a and 80b on the inner surface of the guard side wall 70a and the arc grooves 80c and 80d on the inner surface of the guard side wall 70b. The arc grooves 80a-d extend upwards from the guard bottom portion 66 in a basically inclined way. The arc grooves 80a-d are positioned at intervals along the circumferences of the inner surfaces of the guard side walls 70a and 70b. The circle centre corresponding to the arc where the arc groove 80a exists is basically concentric to that corresponding to the arc where the arc groove 80b exists. The circle centre corresponding to the arc where the arc groove 80c exists is basically concentric to that corresponding to the arc where the arc groove 80d exists.

As shown in FIGS. 7, 8 and 9, the front portion 44 comprises four housing side walls 82a-d which are correspondingly matched with the four guard side walls 70a-d of the moveable guard 64, and in this embodiment, the adaptor portion is positioned on the outer surfaces of the housing side walls 82a and 82b and matched with the arc grooves 80a-d. The adaptor portion usually is a protrusion which is received in the arc grooves 80a-d and can move therein.

In this embodiment, the adaptor portion comprise a cylinder 84 having a through-hole in the centre, a pin 86 passes through the through-hole and therefore its two ends are exposed from the through-hole, the pin 86 and the through-hole of the cylinder 84 are in clearance fit to make the cylinder 84 rotate around the pin 86, the side walls 82a and 82b have grooves 88 for receiving the adaptor portion, square grooves 88a are formed on the middle parts of the grooves 88 for partly receiving the cylinder 84, and cylindrical grooves 88b matched with both ends of the pin 86 exposed from the through-hole in shape are formed at the two ends of the grooves 88. The cylinder 84 is partly received in the semi-cylindrical groove 88a, both ends of the pin 86 are received in the cylindrical groove 88b, and the cylinder 84 and the square groove 88a keep a certain clearance to ensure that the cylinder 84 is able to rotate in the square groove 88a. In this embodiment, both ends of the pin 86 and the cylindrical groove 88b are in an interference fit to make it difficult for the whole adaptor portion to fall off of the front portion 44.

Of course, the pin 86 and the cylinder 84 may be fixedly connected, and both ends of the pin 86 and the cylindrical groove 88b may be in a clearance fit, so the pin 86 and the cylinder 84 rotate together.

The cylinder 84 and the pin 86 are usually made of metallic materials, such as steel, which ensures light abrasion and high strength.

The housing side walls 82a-d comprise the outer surface of the side walls, when the moveable guard 64 is installed on the front portion 44, the inner surfaces of the guard side walls 70a-d of the moveable guard 64 are adjacent to the outer surfaces of the housing side walls 82a-d of the front portion 44. The adaptor portion is positioned on the outer surfaces of the housing side walls 82a-b, four adaptor portions positioned on the outer surface of the housing side wall 82a are divided into two groups, the two adaptor portions in each group are basically arrayed in parallel to the extension directions of the corresponding arc grooves 80a-b, the adaptor portions of the two groups are positioned at intervals along the circumference of the front portion 44, and each group of adaptor portions are positioned corresponding to the arc grooves 80a-b on the inner surfaces of the moveable guard 64. Like the housing side wall 82a, the housing side wall 82b also has two groups of adaptor portions which are positioned corresponding to the arc grooves 80c-d respectively.

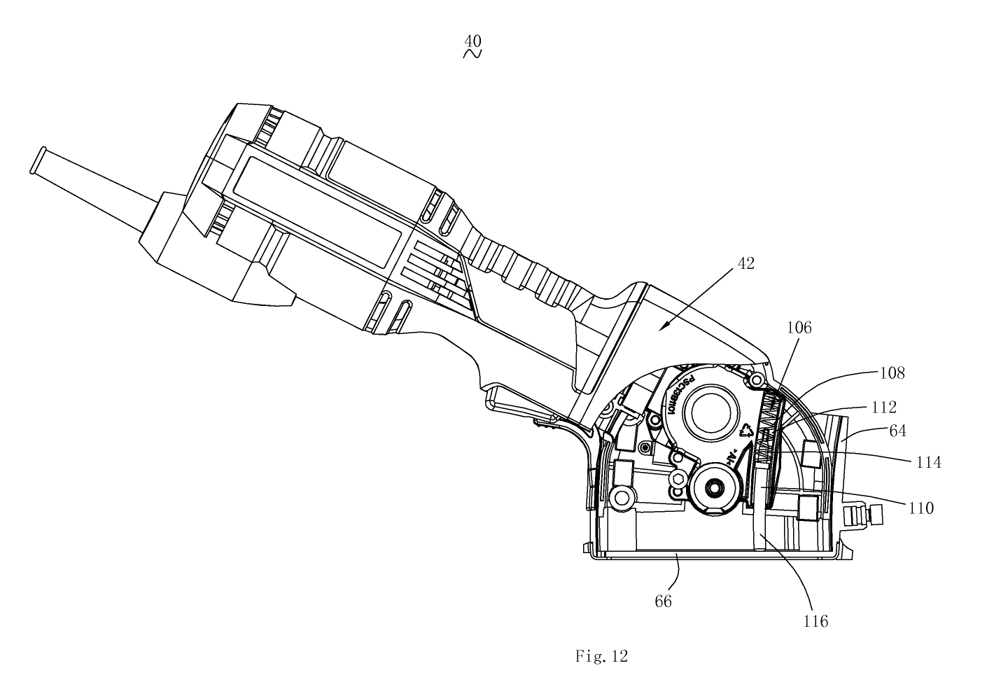

As shown in FIGS. 10 and 11, a portable cutting tool 40 comprises a depth adjusting mechanism 90 for adjusting the cutting depth. The housing side wall 82a has an arc opening 92. The extension direction and radian of the arc opening 92 are basically the same as those of the arc grooves 80a-d. An arc receiving plate 94 is received in the arc opening 92. The depth adjusting mechanism 90 is movably received in the arc receiving plate 94. The depth adjusting mechanism 90 comprise a sliding block 96 which is movably installed in the arc receiving plate 94.

A cam wrench 98 is pivotally connected to the sliding block 96. The cam wrench 98 comprises a cam portion 100 and a wrench portion 102. By operating the wrench 102, the cam portion 100 is pivoted to clamp or loosen the depth adjusting mechanism 90 with respect to the housing side wall 82a. The sliding block 96 is fixedly connected with a pointer 104 for pointing at the adjusting depth. Scales (not shown in the figure) are marked on one side of the arc opening 92, representing the depths of the blade. The pointer 104 points at the scale on one side of the arc opening 92 to display the blade depth adjusted currently.

At work, when the depth is required to be adjusted, the wrench portion 102 is lifted first to put the cam wrench 98 in the open position, the sliding block 96 is moved along the arc opening 92, so the pointer 104 points at the required scale. After the depth is adjusted, the wrench portion 102 is pressed down to put the cam wrench 98 in the closed position, and then the sliding block 96 is locked at a certain position of the arc opening 92. When the workpieces are being cut, the base plate 68 is partly pressed on the workpiece, the operator grips the gripping portion 48 to apply a force to the gripping portion 48, at this time the housing 42 moves along the arc respect to the moveable guard 64 until the upper edge 78 of the moveable guard 64 contacts the cam portion 100 of the cam wrench 98, and then the circular blade 56 exposed from the moveable guard 64 at a certain depth can be processed.

As shown in FIG. 12, a portable cutting tool 40 comprises a rebound mechanism 106 which ensures the moveable guard 64 moves from the second position to the first position respect to the housing 42. In this embodiment, the rebound mechanism 106 comprises a spiral spring 108 and a dowel 110. A portable cutting tool 40 further comprises a gear drive (not shown in the figure) which is received in a gearbox case (not shown in the figure), the gearbox case has a guiding hole 112 for receiving the spiral spring 108 and part of the dowel 110, one end of the spiral spring 108 is pressed against the gearbox case, the dowel 110 comprises a small diameter end 114 and a large diameter end 116, the small diameter end 114 is sleeved with the spiral spring 108, and the large diameter end 116 is pressed against the guard bottom portion 66, and the spiral spring 108 applies a pressing force to the dowel 110 towards the guard bottom portion 66.

As shown in FIG. 13, a width-cutting indicating mechanism is positioned between the moveable guard 64 and the base plate 68. The width-cutting indicating mechanism comprises a plurality of indicating blocks 118. The indicating blocks 118 are movably installed on the guard side walls 70a-b for indicating the most front and rear ends of the circular blade 56 when the circular blade 56 are exposed from the moveable guard 64.

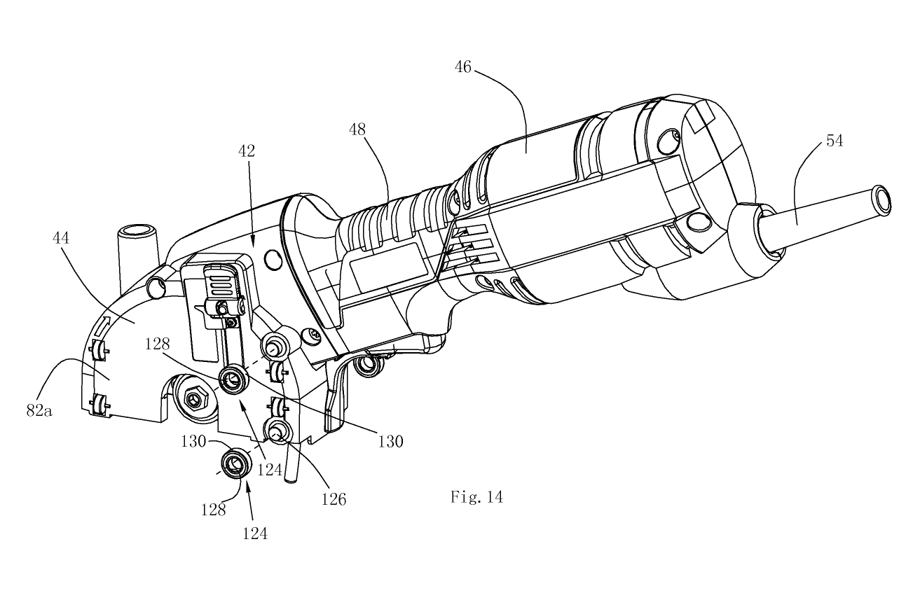

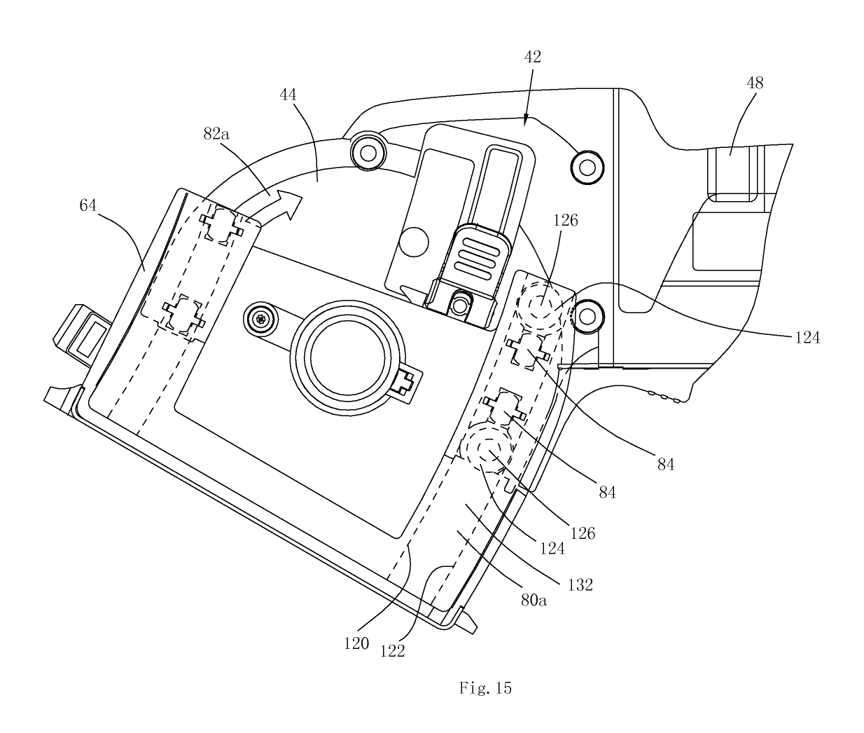

As shown in FIGS. 14 and 15 and further as shown in FIGS. 4 and 5, a portable cutting tool 40 further comprises position-limiting members. The arc guide rail is positioned at either of the moveable guard 64 or the housing 42, and the position-limiting members are positioned at the other of the moveable guard 64 and the housing 42, and the position-limiting members are matched with the guide rail to limit the displacement of the moveable guard 64 along the normal direction of the arc guide rail.

In one embodiment of the present invention, the arc guide rail matched with the position-limiting members refers to the arc grooves 80a and 80b, and the arc groove 80a and the position-limiting members matched are primarily described below.

The arc groove 80a comprises a first arc side surface 120 and a second arc side surface 122 which is concentrically positioned on two corresponding inside walls of the arc groove 80a respectively.

The position-limiting members are divided into a first group and a second group. The first group of position-limiting members is selectable to make contact with the first or second arc side surface linearly, and the second group position-limiting members are selectable to make contact with the first or second arc side surface linearly.

The first and second groups of position-limiting members are the same bearing 124. A protruding rod 126 extending outwards is installed on the housing side wall 82a. The bearing 124 is installed on the protruding rod 126. The bearing 124 comprise a bearing inner race 128 and a bearing cup 130. The bearing cup 130 is able to rotate with respect to the bearing inner race 128. The bearing inner race 128 and the protruding rod 126 are in an interference fit. Two bearings 124 and two cylinders 84 are received in the arc groove 80a. The two cylinders 84 are positioned between the two bearings 124 or on the outsides of the two bearings 124.

The arc groove 80a has a groove bottom surface 132. The cylinders 84 are matched with the grove bottom surface 132 and can roll along the groove bottom surface 132, and the cylinders 84 and the groove bottom surface 132 are in linear contact.

During operation, the operator presses the gripping portion 48 to make the moveable guard 64 move from the first position to the second position respect to the housing 42, the bearing 124 as the position-limiting member in the first group is operable to linearly contact either of the first arc side surface 120 and the second arc side surface 122 and keep a certain clearance with the other of the two; meanwhile, the bearing 124 as the position-limiting member in the second group is operable to linearly contact the first arc side surface 120 or the second arc side surface 122 which is not in linear contact with the bearing 124 as the position-limiting member in the second group and keep a certain clearance with the other of the two.

FIG. 15 is a state diagram of a certain moment of the moveable guard 64 moving respect to the housing 42, the bearing 124 as the position-limiting member in the first group is in linear contact with the first arc side surface 120 and keeps a certain space from the second arc side surface 122; meanwhile, the bearing 124 as the position-limiting member in the second group keeps a certain space from the first arc side surface 120 and is in linear contact with the second arc side surface 122.

When the guard moves to the second position with respect to the housing, the operator grips the gripping portion 48 to move the portable cutting tool forward or backward, and the bearings as the first and second position-limiting members are operable to make contact with either of the first and second arc side surfaces linearly at the same time.

Like the arc groove 80a, the arc groove 80d also receives the position-limiting members identical with the first and second groups of position-limiting members to make the position-limiting effect better.

Of course, the number of the position-limiting members is not limited by the above description.

### Embodiment 2

As shown in FIG. 16, this embodiment is basically the same as the embodiment 1, but is different in that the arc guide rail matched with the position-limiting members is not the original arc groove, but another arc opening 134 of which the radian is identical with that of the mentioned arc groove. The arc opening 134 has a first arc side surface 136 and a second arc side surface 138 on two opposite sides, the first and second groups of position-limiting members are two bearings 140 respectively, the two bearings 140 as the position-limiting member in the first group are located on both sides of the arc opening 134 and are operable to make contact with the first arc side surface 136 or the second arc surface 138 linearly.

FIG. 16 is a state diagram of a certain moment of the moveable guard 64 moving respect to the housing 42, one bearing 140 as the position-limiting member in the first group is in linear contact with the first arc side surface 136, while the other bearing 140 as the position-limiting member in the first group keeps a certain space from the second arc side surface 138; meanwhile, one bearing 140 as the position-limiting member in the second group keeps a certain space from the first arc side surface 136, while other bearing 140 as the position-limiting member in the second group is in linear contact with the second arc side surface 138.

### Embodiment 3

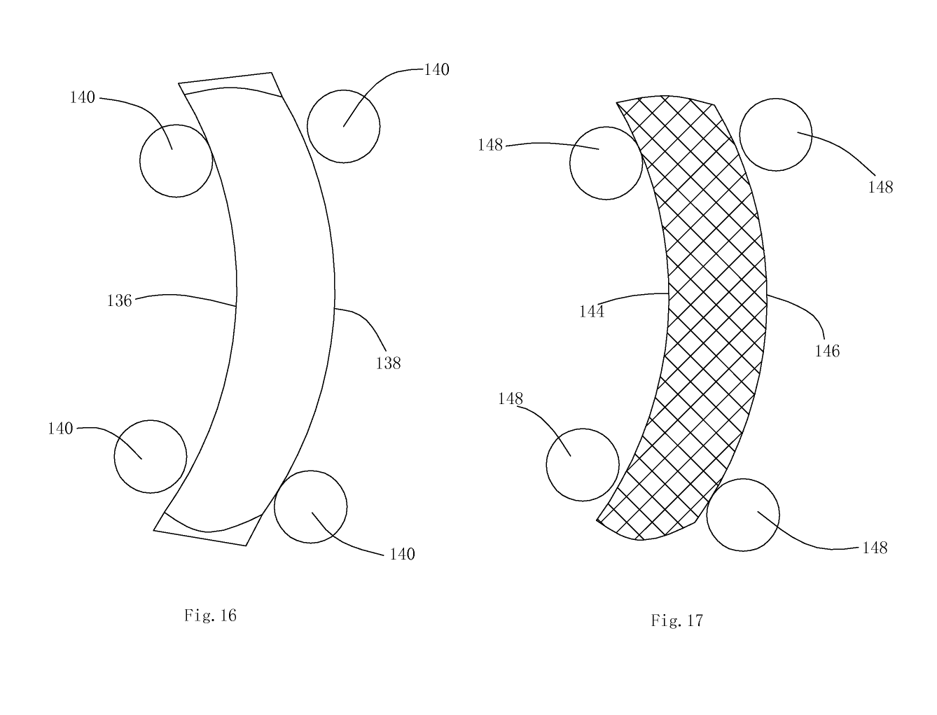

As shown in FIG. 17, this embodiment is basically the same as the embodiment 1 (not shown in the figure), but is different in that the arc guide rail matched with the position-limiting members is not the original arc groove, but another arc protrusion 142 of which the radian is identical with that of the mentioned arc groove. The arc protrusion 142 has a first arc side surface 144 and a second arc side surface 146 on two opposite sides, the first and second groups of position-limiting members are two bearings 148 respectively, the two bearings 148 are located on two sides of the arc protrusion 142 and are operable to make contact with the first arc side surface 144 or the second arc surface 146 linearly.

FIG. 17 is a state diagram of a certain moment of the moveable guard 64 moving respect to the housing 42, one bearing 148 as the position-limiting member in the first group is in linear contact with the first arc side surface 144, while the other bearing 148 as the position-limiting member in the first group keeps a certain space from the second arc side surface 146; meanwhile, one bearing 148 as the position-limiting member in the second group keeps a certain space from the first arc side surface 144, while other bearing 148 as the position-limiting member in the second group is in linear contact with the second arc side surface 146.

### Embodiment 4

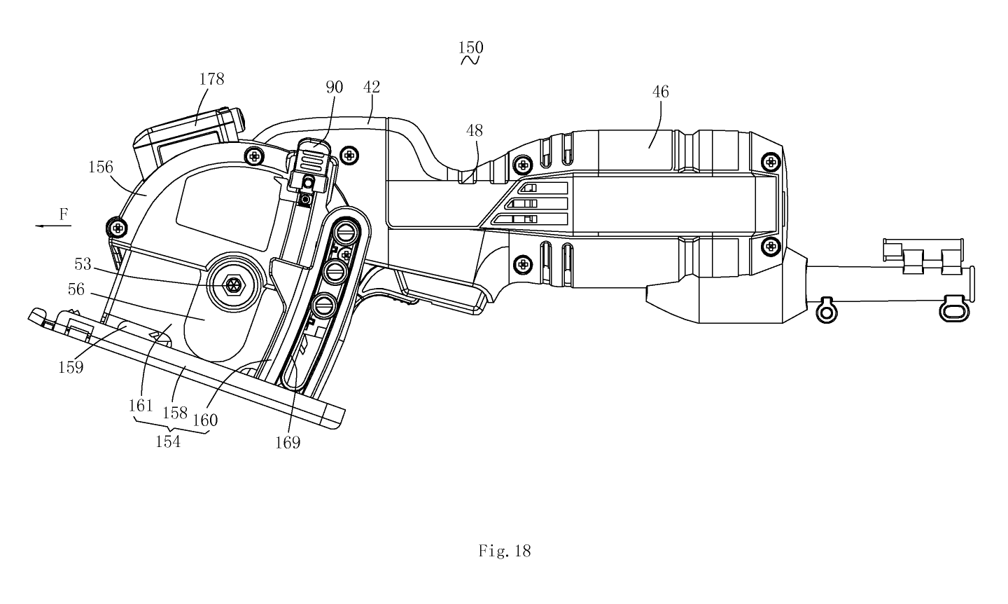

As shown in FIG. 18, the embodiment 4 of the present invention provides a portable cutting tool 150, comprising a guard 154, a housing 42 and a circular blade 56 received in the guard 154, wherein the housing 42 has a front portion 156, a rear portion 46 receiving a motor and a gripping portion 48 positioned between the front portion 156 and the rear portion 46. The portable cutting tool 150 is basically the same as the portable cutting tool 40 provided in the mentioned embodiments in the aspect of functional structure and also has some differences which are described only due to the space limitations.

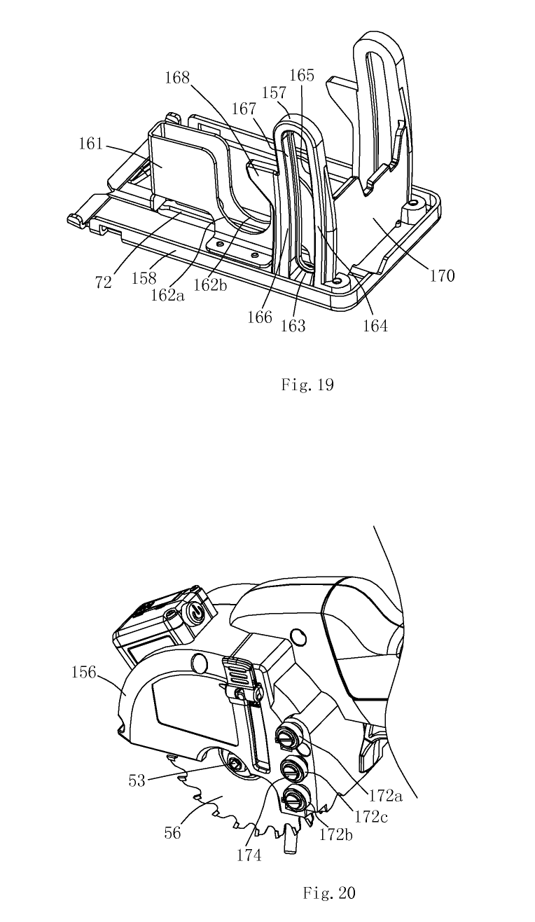

As shown in FIGS. 18 and 19, the guard 154 comprises a bottom portion 158 of the guard for pressing against the workpieces, an arc guide rail 160 by which the portable cutting 150 is matched with the position-limiting members, and a blade receiving cavity 161 for receiving the circular blade 56.

The circular blade 56 has a cutting direction F, the bottom portion 158 of the guard is pressed against the workpiece surface, and a portable cutting tool 150 is pushed along the F direction to cut the workpieces.

The bottom portion 158 of the guard has a longitudinal extension direction and a pressing surface for pressing against the workpieces, and the face is basically rectangular. The bottom portion 158 of the guard has a blade through-hole 72 of which the extension direction is identical with the longitudinal extension direction.

The blade receiving cavity 161 is installed on the surface, back to the pressing face, of the bottom portion 158 of the guard and corresponds to the position of the blade through-hole 72, when the guard 154 is installed on the potable cutting tool 150 and moves between the first position and the second position, the blade receiving cavity 161 is partly received in the front portion 156 to make potable cutting tool 150 small in size, so the space in the front portion 156 is rationally utilized. The blade receiving cavity 161 forms a cavity of which the cross section is identical with and corresponding to the shape of the blade through-hole 72, so the circular blade 56 is capable of being received in the cavity. A recess 162a and a recess 162b are respectively formed at the middle position of a pair of side walls, extending in the same direction, of the blade receiving cavity 161 and the blade through-hole 72, when the circular blade 56 is received in the blade receiving cavity 161, and the recess 162a and the recess 162b are able to receive the tool shaft 53 of the circular blade 56 to ensure that the blade receiving cavity 161 does not hinder the movement of the guard 154 between the first position and the second position.

A through-hole 159 running through the blade receiving cavity 161 is positioned at a position, close to the blade through-hole 72, of the blade receiving cavity 161, and when the guard 154 is installed on the potable cutting tool 150, the projection of the tool shaft 53 on the pressing face is located at middle position between the projections of the through-hole 159 and the arc guiding rail 160 on the pressing face. When cutting the workpieces, the user can clearly observe the position of the circular blade 56 via the through-hole 159, and thus, the cutting precision is effectively improved. Besides, the blade receiving cavity 161 can be partly received in the front portion 156 and is close to the circular blade 56, and the chips generated by the circular blade 56 in the cutting process are smoothly discharged from the through-hole 159, so the dust removal of the whole mechanism is very smooth.

Two arc guiding rails 160 extend along the longitudinal directions respectively and are installed on the surface, back to the pressing face, of the bottom portion 158 of the guard and respectively installed on one side of the blade receiving cavity 161. The two arc guiding rails 160 are positioned face to face and in parallel and are bent at a certain radian towards the surface along the longitudinal directions. After the guard 154 is installed on the portable cutting tool 150, the circle centers of the arc guiding rails 160 are located outside the guard 154 and the portable cutting tool 150 and on one side away from the rear portion 46, and the arc guiding rails 160 and the tool shaft are positioned on one side opposite to the cutting direction F, namely positioned between the tool shaft 53 and the motor in the rear potion 46, so the tool shaft 53 has no guide mechanism on the side towards the cutting direction, and the position of the circular blade can be observed clearly from the through-hole 159.

After the guard 154 is installed on the portable cutting tool 150, the arc guiding rails 160 are exposed in the sightline of the user, namely not shielded by the housing 42 or the guard 154. Such configuration makes the guard 154 very easily installed on or dismantled from the housing 42 of the portable cutting tool 150, the user is able to observe the matching state of the position-limiting members and the arc guiding rails 160 clearly, even if the position-limiting members and the arc guiding rails 160 fail to match with each other, the reasons can be seen easily, and thus, the convenience is brought to the user.

The two arc guiding rails 160 are identical in structure, respectively comprising a distal end 157 of the guide rail away from the bottom portion 158 of the guard, a bottom portion 163 of the guide rail connected to the bottom portion 158 of the guard, and a first guide rail side surface 164 and a second guide rail side surface 166 are which positioned between the distal end 157 of the guide rail and the bottom portion 163 of the guide rail and extend at an equal interval. The distal end 157 of the guide rail and the bottom portion 163 of the guide rail are used for limiting the movement scope of the position-limiting members to avoid the position-limiting members departing from the arc guiding rails 160.

The first guide rail side surface 164 and the second guide rail side surface 166 have the same radian in the longitudinal extension directions thereof, so the guiding rail formed by the first guide rail side surface 164 and the second guide rail side surface 166 have a certain radian. The surface, facing the second guide rail side surface 166, of the first guide rail side surface 164 is a first arc side surface 165, and the surface, facing the first arc side surface 165, of the second guiding rail side surface 166 is a second arc side surface 167. When the guard 154 is assembled onto a portable cutting tool 150, the two arc guiding rails 160 are capable of being matched with a portable cutting tool 150 to limit the displacement scope of the guard 154 respect to the front portion 156.

Both the first arc side surface 165 and the second arc side surface 167 are provided with protrusions 169 matched with the position-limiting members to limit the position of the guard 154 and prevent the guard 154 from sliding along the direction vertical to the plane of the circular blade 56 with respect to the portable cutting tool 150. In this embodiment, the opposite surfaces of the distal end 162 of the guide rail and the bottom portion 163 of the guard rail are also correspondingly provided with protrusions 169, so the position-limiting members and the arc guiding rails 160 are matched more stably.

A position-limiting protrusion 168 extending from the middle position on one side, back to the first guide rail side surface 164, of the second guide rail side surface 166, is able to be matched with the depth adjusting mechanism 90 of the portable cutting tool 150 to limit the cutting depth of the portable cutting tool 150. Of course, the portable cutting tool 150 usually has only one depth adjusting depth 90, so the two arc guiding rails 160 may not both have the position-limiting protrusion 168, and the position-limiting protrusion 168 can be set on the arc guiding rails 160 matched with the depth adjusting device 90 according to demands.

To strength the stresses of the two arc guiding rails 160, a side wall 170 of the guard is positioned between the second guide rail side surfaces 166 of the two arc guiding rails 160, so the two arc guiding rails 160 are difficult to change shape and therefore the service life is prolonged. Of course, to simplify the structure of the guard 154, one arc guiding rail 160 may be positioned on one side, facing the blade receiving cavity 161, of the middle position of the side wall 170 of the guard, correspondingly the position-limiting members is positioned on the inner side of the front portion 156 and matched with the arc guiding rail 160, so the guard 154 is able to slide respect to the portable cutting tool 150.

As shown in FIGS. 18 and 20, The position-limiting members are respectively positioned on the outsides of the two side walls, vertical to the axis of the tool shaft 53, of the front portion 156 of the portable cutting tool 150, and the position-limiting members on each side are all located on one side, opposite to the cutting direction F, of the too shaft 53, namely located between the tool shaft 53 and the motor in the rear portion 46. The position-limiting members on each side are divided two groups, wherein the first group is in linear contact with the first guide rail side surface 164 of the arc guiding rail 160, and the second group is in linear contact with the second guide rail side wall 166.

Each group comprises at least one position-limiting member, which means that at least two position-limiting members are matched with each arc guiding rail 160. When both first and second group comprises one position-limiting member, the first and second groups of position-limiting members on the two sides of the housing 42 are matched with the first and second side surfaces in a reversed way, which means that the first group of position-limiting member on one side of the housing 42 is in linear contact with the first side surface, the second group of position-limiting member is in linear contact with the second side surface, then the first group of position-limiting member on the other side of the housing 42 is linear contact with the second side surface, while the second group of position-limiting member on the other side of the housing 42 is linear contact with the first side surface. Such configuration can prevent the guard 154 from shaking to ensure that the guard 154 is able to slide stably respect to the housing 42.

In this embodiment, the first group has a first position-limiting member and a second position-limiting member which are in linear contact with the first arc side surface 165, the second group has a third position-limiting member which is located between the first and second position pieces along the extension direction of the arc guiding rail 160 and is in linear contact with the second arc side surface 167, and thus, the displacement of the guard 154 along the normal direction of the arc guiding rail 160 effectively restrained.

Of course, the positions of the first, second and third position-limiting members are not limited to be in linear contact the first arc side surface 165 and the second arc side surface 167 respectively, the first and third position-limiting members may be set to make contact with the first arc side surface 165 linearly, and the second position-limiting member may contact the second arc side surface 167 linearly, or the second and third position-limiting members may be set to make contact with the first arc side surface 165 linearly, and the first position-limiting member may be set to make contact with the second arc side surface 167 linearly. Those skilled in this field may make other modifications which shall be within the protection scope of the present invention as long as the functions and effects are identical with or similar to those of the preset invention.

In this embodiment, the first, second and third position-limiting members are identical in structure and are respectively the bearing 172a, bearing 172b and 172c, the outer diameters of the three bearings are smaller than the distance from the first arc side surface 165 to the second arc side surface 167 and greater than the distance from the protrusion 169 of the first guide rail side surface 164 to the protrusion 169 of the second guide rail side surface 166. The structures of the mentioned three bearings are identical with that of the bearing 124 in the first embodiment and therefore detailed description is omitted. When the guard 154 is installed on a portable cutting tool 150, the protrusions 169 are positioned among the three bearings and the front portion 156 of the housing.

Of course, the dimensions of the three bearings are not limited to those in the mentioned description, the outer diameters of the three bearings may also be equal to the distance from the first arc side surface 165 to the second arc side surface 167, at this time the first, second and third position-limiting members contact the first arc side surface 165 and the second arc side surface 167 linearly simultaneously. Those skilled in this field may make other modifications which shall be within the protection scope of the present invention as long as the functions and effects are identical with or similar to those of the preset invention.

The installation means of the bearings 172a-c may be identical with that of the bearing 124 in the first embodiment, but in this embodiment, the bearings 172a-c are installed on the front portion 156 of the housing via screw pins 174a-c.

The installed structures of the three bearings and the three screw pins are the same, so only the fitting method between the screw pin 174a and the bearing 172a is described in detail.

The screw pin 174a comprises a pin head and pin tail, the pin tail is able to pass through the inner race of the bearing 172a and is in threaded connection to the front portion 156 of the housing to clamp the bearing 172 between the pin head and the protrusion 169, so the position of the bearing 172a is fixed, in the same way, the positions of the bearing 172b and the bearing 172c are fixed. At this time, the protrusions 169 of the two arc guiding rails 160 are clamped between the position-limiting members on two sides of the front portion 156 of the housing to restrain the guard 154 from swinging respect to the front portion 156 of the housing, so the stability of the cutting is improved.

When the guard 154 is assembled onto the portable cutting tool 150, the two arc guiding rails 160 are respectively matched with the position-limiting members on two sides of the front portion 156 of the housing to make the guard 154 slide respect to the portable cutting tool 150 and the blade receiving cavity 161 received in the front portion 156 of the housing. Meanwhile, the user can adjust the position of the depth adjusting device 90 to limit the cutting depth of a portable cutting tool 150, which means when the guard 154 slides at a certain distance along the position-limiting members, the position-limiting protrusions 168 will push against the depth adjusting device 90 to realize deep cutting.

As shown in FIG. 18, when the guard 154 is installed on the portable cutting tool 150, the arc guiding rails 160 and the position-limiting members form a guard-guiding mechanism by which the guard 154 stably slides respect to the front portion 156 of the housing. Besides, when the guard-guiding mechanism is wholly located on one side, opposite to the cutting direction F, of the tool shaft 53, namely between the tool shaft 53 and the motor in the rear portion 46 of the housing, the through-hole 159 on one side, away from the housing 42, of the tool shaft 53 is not shielded by the guard-guiding mechanism, so the user can observe the position of the circular blade 56 clearly via the through-hole 159 without obstacle, and cutting becomes convenient.

In case of one arc guiding rail 160, at least two, preferably three position-limiting members can be positioned in the front portion 156 of the housing and close to the housing 42 to be matched with the arc guiding rail 160, and the guard-guiding mechanism formed by the position-limiting members and the arc guiding rail 160 is wholly located on one side, away from the cutting direction F, of the tool shaft 53, namely between the tool shaft 53 and the motor in the rear portion 46 of the housing, which the guard-guiding mechanism is very simply structured, so the overall cost is lower, and the whole structure is easier to assemble.

The positions of the arc guiding rail 160 and the position-limiting members may be exchanged, which means the arc guiding rail 160 may be positioned at the position, corresponding to the position-limiting members, of the front portion 156 of the housing, while the position-limiting members are installed on the guard 154, which means that an installation arm is positioned at a position corresponding to the arc guiding rail for installing the position-limiting members. Such configuration also makes the guard 154 slide stably respect to a portable cutting tool 150.

The number of the position-limiting members is not limited to three, and may be four, five, etc.

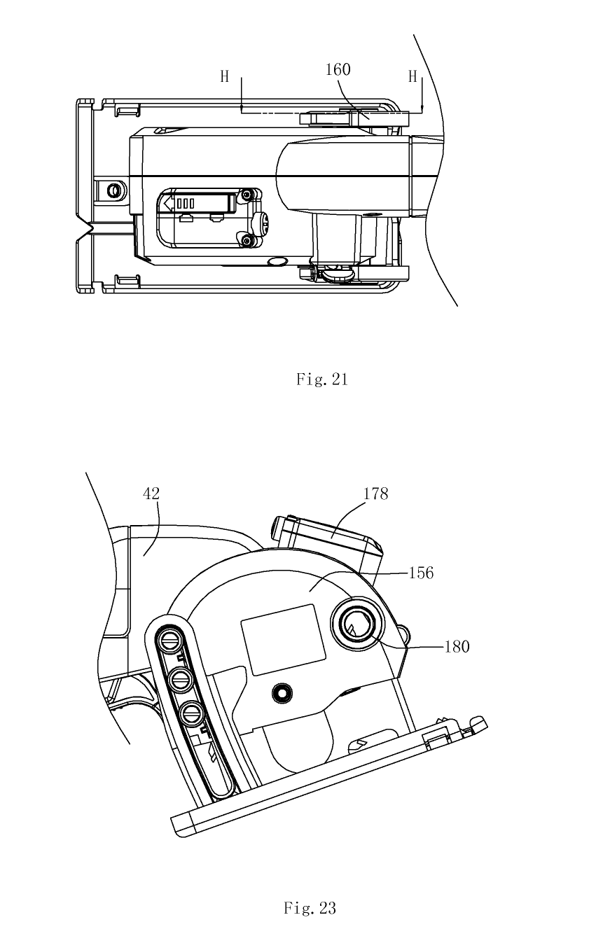

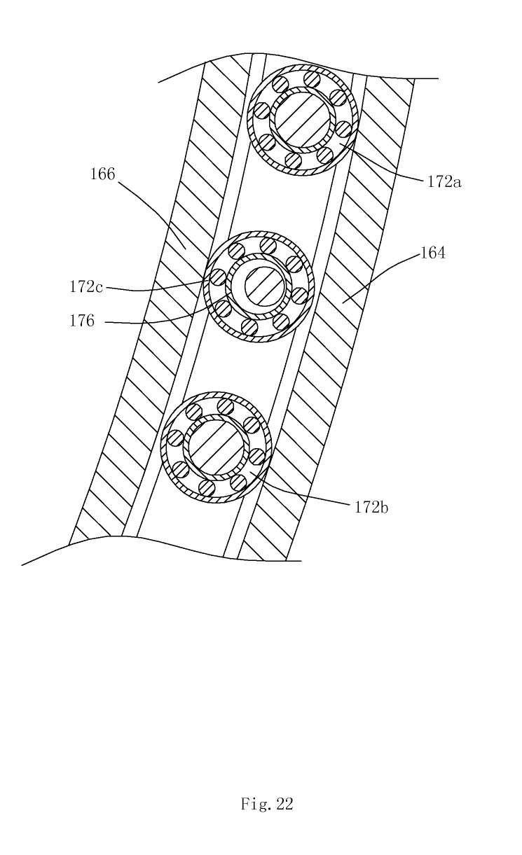

As shown in FIGS. 18, 21 and 22, to facilitate assembly, improve the assembly precision and eliminate tolerance, at least one of the two groups of position-limiting members has the position adjusting function, which means having at least one position-limiting member able to move transversely with respect to the arc guiding rail 160. In this embodiment, the second group of position-limiting member has the position adjusting function, which means the bearing inner race 176 of the bearing 172c and the pin tail keep a gap to make the bearing 172c certainly deviated relative to central line of the screw pin 174, so the bearing 172c moves transversely with respect to the arc guiding rail 160. To install the third bearing, the positions of the bearings 172a-b may be fixed first and then pressed against the first arc side surface 65, and the bearing 172c is pressed against the second arc side surface 167 by adjusting its transverse movement with respect to the arc guiding rail 160, so the tight fit between the position-limiting members and the arc guiding rail 160 is realized and the tolerance is eliminated.

The first group of position-limiting members may also have the position adjusting function. In this embodiment, the first and second position-limiting members in the first group do not have the position adjusting function, which means both the bearing 172a and the bearing 172b are coaxial to the screw pin and are fixed on the front portion 156 of the housing and cannot move transversely with respect to the arc guiding rail 160. Such configuration makes the first, second and third position-limiting members form a triangle, so the formed structure is very firm. When the positions of the position-limiting members and the arc guiding rail 160 are required to be adjusted, only the third position-limiting member is required to be adjusted, and the operation is very simple, which brings convenience to the user.

At most two of all the position-limiting members included in the first and second groups are unable to move transversely with respect to the arc guiding rail 160, and then the tolerance is eliminated via the adjustable position-limiting member. If two position-limiting members in the first group are unable to move transversely with respect to the arc guiding rail 160, all position-limiting members in the second group are able to move transversely with respect to the guiding rail 160. If one position-limiting member in the first group is unable to move transversely with respect to the guiding rail 160, at most one position-limiting member in the second group is able to move transversely with respect to the guiding rail 160, vice versa. In such configuration, the manufacturing tolerance can be eliminated by adjusting the position-limiting member which is able to move transversely with respect to the arc guiding rail 160 to make the fitting between the guard 154 and the arc guiding rail 160 smoother.

In case of four position-limiting members, the first group may include the first, second and third position-limiting members which may be in linear contact with the first arc side surface 165, and the second group may include the fourth position-limiting member which may be in linear contact with the second arc side surface 167.

At this time, at most two of the position-limiting members in the first group are unable to move transversely with respect to the arc guiding rail 160, such as the first and second position-limiting members, the third one is able to move transversely with respect to the arc guiding rail 160. If the first, second and third position-limiting members all are unadjustable, the three may fail to make contact with the first arc side surface 165 linearly at the same time because of the manufacturing precision, and then the tolerance cannot be eliminated by adjusting the transverse movement of the position-limiting members respect to the arc guiding rail 160. In case that the first group has two position-limiting unable to move transversely with respect to the arc guiding rail 160, the fourth position-limiting member in the fourth group must be able to move transversely with respect to the arc guiding rail 160, and in such a way the manufacturing tolerance can be eliminated. Otherwise, the fourth position-limiting member together with the first and second position-limiting members will form a triangle in which the length of the vertical line between the opposite sides of the fourth position-limiting member is fixed, if the three position-limiting members in this triangle are unable to make contact with the side wall of the corresponding arc guiding rail 160 at the same time, this may be because the length of the vertical line is smaller than the width of the arc guiding rail 160, then the tolerance cannot be eliminated by adjusting the third position-limiting member, and the three position-limiting members in this triangle are unable to make contact with the side wall of the corresponding arc guiding rail 160 at the same time.

In case the first group only has one position-limiting member unable to move transversely with respect to the arc guiding rail 160, such as the first position-limiting member, the second and fourth position-limiting members are able to move transversely with respect to the arc guiding rail 160, and then the fourth position-limiting group in the second group may be set to be unable to move transversely with respect to the arc guiding rail 160. Usually, the length of the line segments formed by the first and fourth position-limiting members must be greater than the width of the arc guiding rail 160, so the phenomenon that first and fourth position-limiting members contact the side wall of the arc guiding rail 160 linearly at the same time must exist, at this time, the four position-limiting members can contact the corresponding side walls of the arc guiding rail 160 linearly by adjusting the second and third position-limiting members.

In case of five position-limiting members, the first group may include the first, second and third position-limiting members which are in linear contact with the first arc side surface 165, and the second group may include the fourth and fifth position-limiting members which are in linear contact with the second arc side surface 167. In case the first group has two or three position-limiting members unable to move transversely with respect to the arc guiding rail 160, the situation is like the abovementioned and then the detailed description is thereof omitted. In case at most one of the position-limiting members in the first group is unable to move transversely with respect to the arc guiding rail 160, such as the first position-limiting member, the second and third ones are able to move transversely with respect to the arc guiding rail 160. Then, only one of the position-limiting members in the second group is unable to move transversely with respect to the arc guiding rail 160 so as to avoid the situation that three position-limiting members unable to move transversely with respect to the arc guiding rail 160 form a triangle.

Likely, 6, 7 or 8 position-limiting members all can be set according to the mentioned principle which is not described in details due to the space limitations, and the changes and modifications which adopt the technical solutions and realize the functions identical to or similar to those of the present invention shall be within the protection scope of the present invention.

It can be seen that among three optional position-limiting members, two selected from the first group and one selected from the second group, at most two are unable to move transversely with respect to the arc guiding rail 160; otherwise, the position-limiting members are unable to make contact with the side wall of the arc guiding rail 160 linearly, which causes waste of the position-limiting members or transverse movement of the arc guiding rail 160 to make the guard 154 shake and therefore influence the cutting precision.

Of course, the technical solution for realizing the transverse movement of the position-limiting members with respect to the arc guiding rail 160 is not limited the abovementioned, and may adopt other means, i.e.: the bearing with a large inner diameter and the screw pin are matched; the bearing and the screw pin are coaxially positioned, but a slot extending transversely with respect to the arc guiding rail 160 is positioned at the position where the screw pin is installed on the front portion 156 of the housing; a nut in threaded connection with the screw pin is positioned on the inner side of the front portion 156 of the housing; the position adjustment is realized by the screw pin sliding in the slot; etc., which is not described in details due to the space limitations, and all technical solutions, in which the structures and functions are identical with or similar to those of the present invention, adopted those skilled in this field shall be within the protection scope of the present invention.

The mentioned structures are not limited to the linear contact between the first group of position-limiting members and the first arc side surface 165 and between the second group of position-limiting members and the second arc side surface 167, but may also be set to be the linear contact between the first group of position-limiting members and the second arc side surface 167 and between the second group of position-limiting members and the first arc side surface 165. During assembly, the first group of position-limiting members are installed on the arc guiding rail 160 first and pressed against the second arc side surface 167, and then the second group of position-limiting members are installed on the arc guiding rail 160 and adjusted I position to be pressed against the first arc side surface 165. Such configuration makes the structure more flexible and provides more options for the assembly procedure.

Besides, the position-limiting members at the guide rail are not limited to the matched with the arc guiding rail, the guide rail extending along a straight line may also be adopted in the scheme of the present invention, and the installation modes and fitting structure are all identical with or similar to those in the technical solutions in the embodiments of the present invention, which are not described in details due the space limitations.

As shown in FIGS. 18 and 23, a laser guiding devices 178 is positioned on the side surface, vertical to the plane of the circular blade 56, of the front portion 156 of the housing of a portable cutting tool 150, for guiding the laser when the user cuts the workpeices. The front portion 156 of the housing also has an outlet opening 180 located on the side surface, in parallel to the plane of the circular blade 56, of the front portion 156 of the housing and on one side, away from the housing 42 of the tool shaft 53.

The present invention is not limited to the mentioned embodiments, and those skilled in this field may make other modifications which shall be within the protection scope of the present invention as long as the functions and effects are identical with or similar to those of the preset invention.

What is claimed is:

1. A portable cutting tool, comprising:
a blade for cutting a workpiece, the blade having a blade plane;
a housing;
a movable guard installed on the housing, wherein the movable guard has a blade through-hole through which the blade passes with respect to the movable guard and moves between a first position and a second position, when the movable guard is located at the first position, the blade does not pass through the blade through-hole, and when the movable guard is located at the second position, the blade passes through the blade through-hole;
wherein either the movable guard or the housing is provided with an arc guide rail, and the other has position-limiting members which are matched with the arc guide rail to limit the displacement of the movable guard along the normal direction of the arc guide rail.

2. A portable cutting tool according to claim 1, wherein the arc guide rail is positioned on the movable guard and the position-limiting members are positioned on the housing.

3. A portable cutting tool according to claim 1, wherein the portable cutting tool further comprises an adaptor portion which is matched with the arc guide rail to limit the displacement of the movable guard along the direction vertical to the blade plane.

4. A portable cutting tool according to claim 1, wherein the arc guide rail is an arc groove having a first arc side surface and a second arc side surface, and one of the position-limiting members is received in the arc groove and is operable to make contact with the first arc side surface or the second arc side surface linearly.

5. A portable cutting tool according to claim 1, wherein the arc guide rail has a first guide rail side wall and a second guide rail side wall at an equal interval, two position-limiting members contact the first guide rail side wall linearly, and one position-limiting member makes contact with the second guide rail side wall linearly.

6. A portable cutting tool according to claim 5, wherein the opposite faces of the first and second guide rail side walls are provided with protrusions which are located between the position-limiting members and the housing.

7. A portable cutting tool according to claim 1, wherein the blade has a cutting direction, and wherein the portable cutting tool further comprises a tool shaft for installing and driving the blade, wherein the position-limiting members and the arc guide rail together form a guard-guiding mechanism which is wholly located on one side of the tool shaft which is opposite to the cutting direction.

8. A portable cutting tool according to claim 1, wherein the portable cutting tool further comprises a motor and a tool shaft which is used for installing the blade and is driven by the motor; the housing comprises a front portion for installing the tool shaft and a rear portion for receiving the motor; and wherein the position-limiting members and the arc guide rail together form a guard-guiding mechanism which is wholly located between the tool shaft and the motor.

9. A portable cutting tool according to claim 1, wherein a circle center of the arc guide rail is located outside the portable cutting tool.

10. A portable cutting tool according to claim 1, wherein the arc guide rail is nakedly positioned on the movable guard or on the housing.

11. A portable cutting tool according to claim 1, wherein the position-limiting members are bearings.

12. A portable cutting tool, comprising:
a motor;
a blade for cutting a workpiece;
a tool shaft driven by the motor and used for installing the blade;
a housing having a front portion for installing the tool shaft, a rear portion for receiving the motor, and a gripping portion located between the front portion and the rear portion;
a movable guard installed on the housing, wherein the movable guard has a blade through-hole through which the blade passes with respect to the movable guard and moves between a first position and a second position, and when the movable guard is located at the first position, the blade does not pass through the blade through-hole, and when the movable guard is located at the second position, the blade passes through the blade through-hole;
wherein the motor has a motor fan located on one side of the motor which is away from the front portion.

13. A portable cutting tool, comprising:
a blade;
a housing;
a movable guard installed on the housing, wherein the movable guard has a blade through-hole through which the blade passes with respect to the movable guard and moves between a first position and a second position, and when the movable guard is located at the first position, the blade does not pass through the blade through-hole, and that when the movable guard is located at the second position, the blade passes through the blade through-hole;
wherein either the movable guard or the housing is provided with an arc guide rail, and the other has position-limiting members; the arc guide rail has a first arc side surface and a second arc side surface which are concentric; the position-limiting members are divided into a first group and a second group; wherein the first group of position-limiting members are selectable to make contact with one of the first and second arc side surfaces linearly, and the second group of position-limiting members are selectable to make contact with one of the first and second arc side surfaces linearly.

14. A portable cutting tool according to claim 13, wherein the arc guide rail has a longitudinal extension direction, and at least one of the first and second groups of position-limiting members comprises at least one position-limiting member able to move transversely with respect to the guide rail.

15. A portable cutting tool according to claim 14, wherein among three position-limiting members optionally selected from the first and second groups of position-limiting members, at most two are unable to move transversely with respect to the guide rail.
